(19) United States
(12) Patent Application Publication
(10) Pub. No.: US 2021/0354911 A1
(43) Pub. Date: Nov. 18, 2021

(54) WASTE RECEPTACLE WITH SENSING AND INTERACTIVE PRESENTATION SYSTEM

(71) Applicant: CleanRobotics Technologies, Inc., Pittsburgh, PA (US)

(72) Inventors: Charles Arthur Yhap, Longmont, CO (US); Tanner Cook, Aspen, CO (US); Vaishnavi Krishnamurthy, Pittsburgh, PA (US); Puru Rastogi, Pittsburgh, PA (US); Graeme Austin Rock, Pittsburgh, PA (US); Koushil Sreenath, Pittsburgh, PA (US)

(21) Appl. No.: 17/389,728

(22) Filed: Jul. 30, 2021

Related U.S. Application Data
(63) Continuation-in-part of application No. 15/649,988, filed on Jul. 14, 2017, now Pat. No. 11,104,512.
(60) Provisional application No. 63/059,523, filed on Jul. 31, 2020.
(60) Provisional application No. 62/363,028, filed on Jul. 15, 2016.

(51) Int. Cl. B65F 1/00

(52) U.S. Cl. CPC B65F 1/0033; B65F 2210/138; B65F 2210/168

(57) ABSTRACT

Systems and methods for operating a system. The methods comprise: generating sensor data by at least one sensor of a waste receptacle that specifies at least one characteristic of at least one item; performing operations by the waste receptacle to identify first media content that is associated with the at least one characteristic of the at least one item; causing the first media content to be output from the waste receptacle or an external device when the first media content is identified by the waste receptacle; and selecting second media content different from the first media content and causing the second media content to be output from the waste receptacle or the external device, when the first media content is unable to be identified by the waste receptacle.

### CROSS REFERENCE TO RELATED APPLICATION

This patent document is a Continuation in Part of U.S. patent application Ser. No. 15/649,988 entitled “AUTOMATIC SORTING OF WASTE” which was filed on Jul. 14, 2017 and claims priority to U.S. Provisional Patent Application Ser. No. 62/363,028 filed on Jul. 15, 2016. The patent document also claims prior to U.S. Provisional Patent Application Ser. No. 63/059,523 entitled “WASTE RECEPTACLE WITH SENSING AND INTERACTIVE PRESENTATION SYSTEM” which was filed on Jul. 31, 2020. The contents of these Patent Applications are incorporated herein by reference in their entirety.

### BACKGROUND

### Statement of the Technical Field

The present disclosure relates to receptacles. More specifically, the present disclosure related to implementing systems and methods for identifying types of items placed in a receptacle and causing a changeable medium to react based on the identified types.

### Description of the Related Art

Single-stream recycling plants are only 10% efficient at reclaiming usable material, meaning 90% of waste that enters such recycling plants goes to landfills. The majority of this low efficiency is caused by users failing to throw away their waste in the correct bins, as well as users inserting overly-contaminated recyclables into recyclable bins. Users often face numerous unclear recycling regulations without consequential feedback for their decisions, leading to confusion and/or apathy toward recycling.

Additionally, even in instances where a user disposes of recyclable waste in the appropriate bin or container, the waste may be too contaminated to be processed as anything other than landfill waste. For example, an empty plastic beverage bottle may generally be considered to be recyclable, but a plastic beverage bottle filled with a certain amount of liquid may not be acceptable as a recyclable item at the downstream recycling plant. Similarly, corrugated cardboard may generally be considered to be recyclable, but cardboard materials contaminated with food, grease, etc. may no longer be acceptable as a recyclable item. Regardless, many users still place these contaminated items in a corresponding recycling bin, resulting in the need to sort and dispose of the contaminated item at the downstream recycling plant, which adds significant time and expense to the recycling process. Furthermore, contaminated recyclable products that are placed in recycling bins may lead to the contamination of commingled, otherwise-recyclable items, further reducing the efficiency of reclaiming reusable materials.

### SUMMARY

The present document relates to implementing systems and methods for operating a system. The methods comprise: generating sensor data by at least one sensor of a waste receptacle that specifies at least one characteristic of at least one item; and performing operations by the waste receptacle to identify first media content that is associated with the at least one characteristic of the at least one item. When the first media content is identified by the waste receptacle, the waste receptacle or an external device is caused to output the first media content. However, when the first media content is unable to be identified by the waste receptacle, second media content is selected. The second media content is different than the first media content. The waste receptacle or the external device is then caused to output the second media content. The external device may comprise (i) a mobile communication device of an individual who has or has possession of the at least one item or (ii) a presentation device located near the waste receptacle device.

The characteristic(s) of the item include, but are not limited to, a type of item, a type of waste that the at least one item comprises, a physical appearance of the at least one item, a condition of the at least one item, a source of the at least one item, a tradename for the at least one item, a product identifier for the at least one item, label information for the at least one item, contents of the at least one item, a group to which the at least one item belongs, a ranking or importance of the at least one item relative to other items, and/or a ranking or importance of the source of the at least one item relative to a source of at least one other item.

The methods may also comprise performing operations by the waste receptacle to detect when a first item and a second item is disposed therein within a period starting from when the first item was detected in proximity to the waste receptacle. The sensor data specifies characteristics of the first item and the second item. The characteristics of the first and second items are used to obtain information comprising at least one of an identifier for a group to which the first and second items belong, an identification of a common source for the first and second items, relative importance for the first and second items, and a weighted value.

The second media content may be selected randomly. Alternatively, the second media content is selected based on a time of day, a geographic location of the waste receptacle, a total number of individuals detected in proximity to the waste receptacle at a given time, physical characteristics of individuals proximate to the waste receptacle, types of electronic devices in possession of the individuals proximate to the waste receptacle, a given degree of the at least one item's popularity amongst a population, or an average number of items processed by the waste receptacle in a given period.

Additionally or alternatively, the sensor data is analyzed to obtain individual-based information that is used to select the second media content. The individual-based information can include, but is not limited to, an identifier for an individual proximate to the waste receptacle, information indicating a popularity of an item type amongst persons having at least one trait in common with the individual proximate to the waste receptacle, and/or information indicating a total or average number of items of the same or similar type that has historically been processed by waste receptacle during a given period.

Implementing systems of the above-described methods can include, but are not limited to, a processor and a non-transitory computer-readable storage medium comprising programming instructions that are configured to cause the processor to implement a method for operating a system.

### BRIEF DESCRIPTION OF THE DRAWINGS

While the accompanying drawings include illustrations of various embodiments, the drawings are not intended to limit the claimed subject matter.

FIG. 1 provides an illustration showing an actuated waste container.

FIG. 2 provides an illustration showing another actuated waster container.

FIG. 3 provides an illustration showing yet another actuated waster container.

FIG. 4 provides a cross-sectional view of the waste container shown in FIG. 1.

FIG. 5 provides an illustration showing an actuated sorting compartment.

FIG. 6 provides an illustration showing another sorting compartment.

FIGS. 7A-7C (collectively referred to as “FIG. 7”) provide illustrations showing yet another sorting compartment.

FIG. 8 provides a flow diagram of an illustrative method for processing a piece of waste within a waste container.

FIG. 9 provides a flow diagram of an illustrative method for determining a type of waste placed within a waste container.

FIG. 10 provides a flow diagram of an illustrative method for determining a type of waste placed within a waste container.

FIG. 11 provides an illustration of an architecture for a circuit of a waste container.

FIG. 12 provides an illustration of a waste disposal system.

FIGS. 13A-13B (collectively referred to as “FIG. 13”) provides a flow diagram of an illustrative method for controlling a system.

FIG. 14 provides a flow diagram of an illustrative method for controlling a system.

FIG. 15 provides an illustration of illustrative computing device.

### DETAILED DESCRIPTION

Brief definitions of terms, abbreviations, and phrases used throughout this document are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed therebetween, while not sharing any physical connection with one another. Additionally, the words “herein,” “above,” “below,” and words of similar import, when used in this document, shall refer to this document as a whole and not to any particular portions of this application. Where the context permits, words in this specification using the singular or plural number may also include the plural or singular number respectively. The word “or,” in reference to a list of two or more items, covers all of the following interpretations of the word: any of the items in the list, all of the items in the list, and any combination of the items in the list.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

If the specification states a component or feature “may,” “can,” “could,” or “might” be included or have a characteristic, that particular component or feature is not required to be included or have the characteristic.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

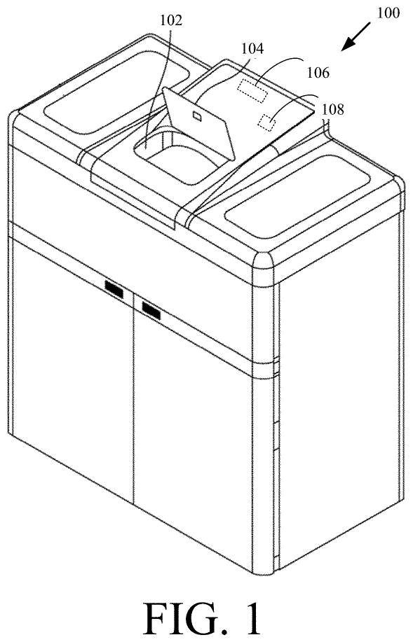

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 1.

In this document, the terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, the terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

In this document, the term “imaging device” refers generally to a hardware sensor that is configured to acquire digital images. An imaging device may capture still and/or video images, and optionally may be used for other imagery-related applications. For example, an imaging device can be held by a user such as a DSLR (digital single lens reflex) camera, cell phone camera, or video camera. The imaging device may be part of an image capturing system that includes other hardware components. For example, an imaging device can be mounted on an accessory such as a monopod or tripod. The imaging device can also be mounted on a transporting vehicle such as an aerial drone, a robotic vehicle, or on a piloted aircraft such as a plane or helicopter having a transceiver that can send captured digital images to, and receive commands from, other components of the system.

In this document, the term “connected”, when referring to two physical structures, means that the two physical structures touch each other. Devices that are connected may be secured to each other, or they may simply touch each other and not be secured.

In this document, the term “electrically connected”, when referring to two electrical components, means that a conductive path exists between the two components. The path may be a direct path, or an indirect path through one or more intermediary components.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

In this document, the term “waste” or trash refers to a discarded or object that is placed into a waste container (such as a trash bin), a recycling container (such as a bin into which objects to be recycled are placed), or a refurbishment/reuse container (such as a container to receive spent ink cartridges or other items that can be cleaned, refilled, or otherwise refurbished and reused). This document may refer to all such containers as a “waste container”, and all such objects as “waste” or “trash”.

The terminology used in this specification is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example, using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

The technology presented here includes systems and methods to: (i) automatically determine the type of waste deposited into a waste container and dispense the waste into an appropriate waste bin (e.g., a recyclable waste bin, a non-recyclable waste bin (e.g., a landfill or compost bin), and/or other waste bins (e.g., a recyclable paper bin or a recyclable plastics bin) without the need for the user to decipher complicated pictures or read lengthy instructions before throwing a piece of waste away; and (ii) provide users of the water container with feedback to, for example, dynamically encourage use of given products.

Waste Container Architectures

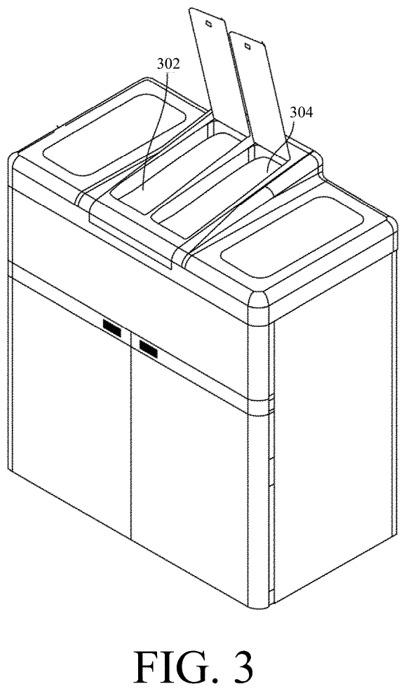

Referring now to FIG. 1, there is provided an illustration of an actuated waste container. The waste container 100 receives a piece of waste through an opening 102. Although one opening is shown in FIG. 1, the present solution is not limited in this regard. The waste container can alternatively be provided with two or more openings 302, 304 as shown in FIG. 3. The openings 302, 304 can be disposed adjacent to each other as shown in FIG. 3 or in another arrangement (e.g., one behind the other, one diagonal with respect to the other, in a vertically stacked arrangement, etc.).

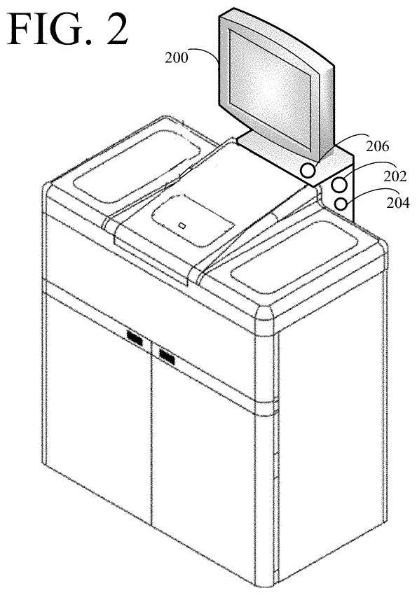

As shown in FIG. 1, the opening 102 can optionally be provided with a cover 104. Cover 104 can include, but is not limited to, a flap, a hinged lid, and/or a sliding door. The cover 104 is configured to toggle or otherwise transition between an open position shown in FIG. 1 and a closed position shown in FIG. 2. Further, the cover 104 can partially close the opening 102. The cover can be opened/closed manually by an individual, responsive to a voice command by an induvial via a microphone (e.g., microphone 202 of FIG. 2) and/or automatically based on sensor data generated by sensors (e.g., a proximity sensor) of the waste container (e.g., a detection of an individual or mobile communication device in proximity thereto).

The waste container 100 is not limited to the single free-standing configurations shown in FIGS. 1-3. For example, a plurality of waste containers can be provided proximate to each other in a room, wall or cabinet. These waste containers can comprise separate waste bins with their own openings and/or garbage chutes in a building. In this case, it may be considered a waste receiving system rather than a single waste container.

The waste container 100 can include a circuit 106 (e.g., a processor, a datastore, a transceiver and/or sensor(s)). The circuit 106 is configured to facilitate the communication of data to/from the waste container. The data can be received from and/or sent to external computing device(s) of, for example, remote data storage facilities via a communication network. The external computing device(s) can include, but is(are) not limited to, a server, a desktop computer, a laptop computer, a mobile device, a personal digital assistant, and/or a smart phone.

The communication network can include, but is not limited to, a data network, a wireless network, a telephony network or any combination thereof. The data network may be any Local Area Network (LAN), Metropolitan Area Network (MAN), Wide Area Network (WAN), a public data network (e.g., the Internet), short range wireless network (such as a Wi-Fi network), a packet-switched network (e.g., a proprietary cable or fiber-optic network and the like) or any combination thereof. The wireless network may be, for example, a cellular network and may employ various technologies including enhanced data rates for global evolution (EDGE), General Packet Radio Service (GPRS), Global System for Mobile (GSM) communications, Internet protocol Multimedia Subsystem (IMS), Universal Mobile Telecommunications System (UMTS), etc., as well as any other suitable wireless medium (e.g., worldwide interoperability for microwave access (WiMAX), Long Term Evolution (LTE) networks, Code Division Multiple Access (CDMA), Wideband Code Division Multiple Access (WCDMA), wireless fidelity (Wi-Fi), Wireless LAN (WLAN), Bluetooth®, Internet Protocol (IP) data casting, satellite, Mobile Ad hoc Network (MANET) or any combination thereof.

The data can include, but is not limited to, sensor data generated by one or more sensor(s) of circuit 106. The sensor(s) can include, but are not limited to, inductive sensor(s), capacitive sensor(s), photoelectric sensor(s), load sensor(s), camera(s), temperature sensor(s), infrared sensor(s), near-infrared sensor(s), spectral imaging sensor(s) (such as spectrometer(s)), audio sensor(s), fluorescence sensor(s), millimeter-wave radar sensor(s), electronic scale(s), and/or odor sensor(s). The sensor data can include, for example, image(s) captured by camera(s), scent(s) captured by odor detection sensor(s), weight(s) determined by electronic scale(s), temperature(s) determined by infrared sensor(s) or temperature sensor(s), and/or an amount of fluid or other substance contained in the item. The circuit 106 of the waste container 100 and/or the external computing device(s) can: process the sensor data to detect when an item is being disposed in the waste container 100, identify a manufacturer of the item, identify a trademark associated with the item, classify the type of item based on the sensor data, and/or identify a condition of the item (e.g., clean or dirty); and/or provide feedback to the individual who disposed of the item based on the results of the sensor data processing. The feedback can include auditory feedback, visual feedback and/or tactile feedback (e.g., via a mobile communication device in possession of the individual). In this regard, the waste container 100 can include output devices such as a display screen 200, a speaker 204 and/or light system 206 (e.g., LEDs or laser lighting system) shown in FIG. 2. These and other operations of the waste container 100 will become more evident as the discussion progresses.

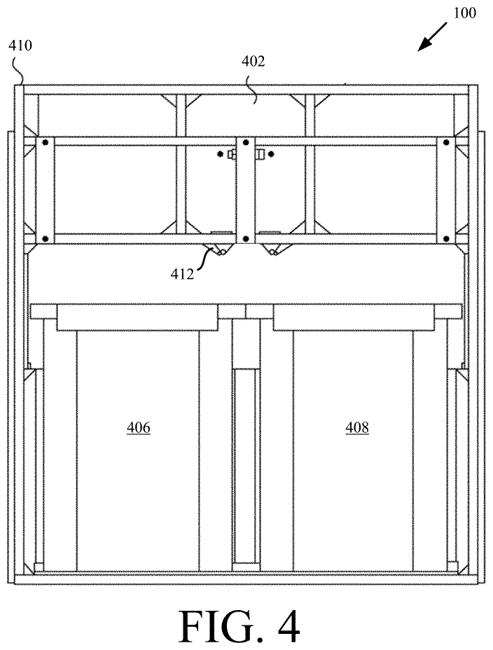

Referring now to FIG. 4, there is provided a cross-sectional view of the waste container 100. Waste container 100 includes a frame 410 with sorting compartment(s) 402 provided therein. The frame 410 can be formed of any kind of structural material (e.g., plastic rods, aluminum bars and/or other metals). The frame 410 structurally supports the sorting compartment(s) 402 above one or more waste bins 406, 408. Each waste bin 406, 408 can be designated for use in collecting items of a given type (e.g., recyclables, landfill garbage, metal, compost, or hazardous waste). The waste bins 406, 408 can be provided for collecting items of the same or different type. After a piece of waste is disposed in the opening 104 of the waste container 100, it travels into the sorting compartment 402. The sorting compartment 402 includes electronic circuitry and mechanical components to sort items and/or controllably direct the items to a given waste bin 406, 408 via a bottom valve or doorway 412 thereof.

The size of the waste container, the number of waste bins and/or the size(s) of the waste bin(s) may be customizable based on local waste disposal regulations. For example, a municipality allowing mixed recycling (i.e., the mixing of most or all recyclable materials in one container or bin) may only necessitate two waste bins (e.g., one for recyclables and one for landfill waste). On the other hand, a municipality requiring sorted recycling (e.g., individual containers or bins for most or all recyclables) may necessitate more than two waste bins.

The sensors(s) of the circuit 106 can be disposed in or proximate to the sorting compartment 402. The sensor(s) are configured to generate sensor data that the waste container 100 and/or a remote computing device can use to identify, sort and direct pieces of waste when it is received in the sorting compartment 402. The sensor(s) can be disposed within, underneath, and/or above the sorting compartment 402 at location(s) that allow the contents within the sorting compartment 402 to be detected and/or identified.

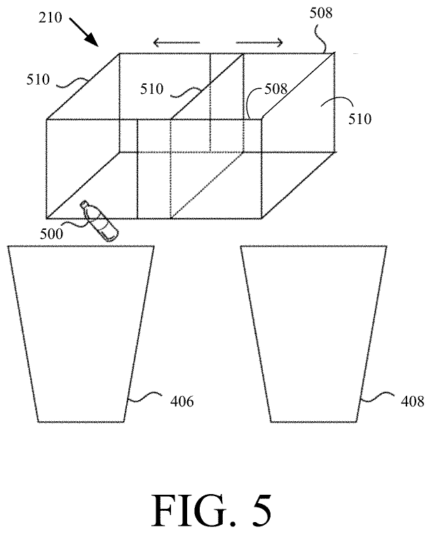

FIG. 5 provides an illustration that is useful for understanding operations of the sorting compartment 402. Sorting compartment 402 is generally configured to receive items 500 and selectively move the items 500 from opening 102 of the waste container 100 into a waste bin 406 or 408 based on the type of waste associated with the items. In this regard, the sorting compartment 402 comprises a first set of walls 508 that are oriented in a first direction and a second set of walls 510 that are oriented in a second direction perpendicular to the first direction. One or more of the walls 510 may be actuated to move the items 500 to a given waste bin 406 or 408.

For example, if the item is a plastic bottle, wall(s) 510 may be actuated to move the same to the left such that it falls into waste bin 406 which is provided to collect recyclable items. If the item is not a recyclable item, wall(s) 510 may be actuated to move the same to the right such that it falls into waste bin 408 which is provided to collect landfill items. Wall(s) 508 can also be actuated to move the item in a third direction towards a front of the waste container and/or in a fourth direction towards a back of the waste container. Movement of walls 508 can facilitate the disposition of items into additional waste bins (not visible in FIG. 5). The present solution is not limited to the particulars of this example. Any number of walls can be configured to move to the left, right, forwards, backwards and/or diagonally. Movement of the walls can be achieved using a servomotor or a direct drive system.

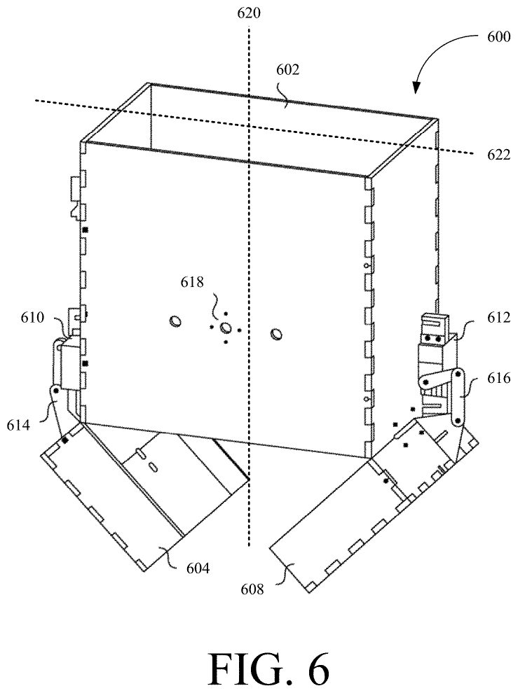

Other types of automated sorting compartments are possible. For example, FIG. 6 shows another illustrative sorting compartment 600. The sorting compartment 600 comprises an opening 400 through which waste can enter the compartment, actuatable exit door(s) 604, 608 through which waste can exit the sorting compartment, and sensors for sensing the types of waste that enter the compartment. The exit doors 410, 420 can be opened/closed via motors and hinges 614, 616. Sensors can be disposed within, underneath, and/or above the one or more actuated sorting opening 602 to sense the contents entering and/or within the sorting compartments 600. As with the previous example, the sensors can include, but are not limited to, inductive sensor(s), capacitive sensor(s), photoelectric sensor(s), load sensor(s), camera(s), temperature sensor(s), odor sensor(s), infrared sensor(s), near-infrared sensor(s), spectral imaging device(s), audio sensor(s), fluorescence sensor(s), and/or millimeter-wave radar sensor(s). The exit door(s) 604, 608 may contain additional sensors such as load sensor(s) and metal detection sensor(s) that are housed underneath a layer of waste-resistant material (e.g., a waterproof lining).

The sorting compartment 600 is configured to move relative to the waste bins. In this regard, a pivot member 618 is provided to facilitate rotatable movement of the sorting compartment. Pivot member 618 can include a post that is rotated or otherwise actuated by a motor (e.g., a servomotor or a direct drive system). The motor/post can cause the sorting compartment 600 to rotate about a horizontal axis 622 and/or rotate about a vertical axis 620. Other mechanical means can be provided in addition to or alternative to the pivot member such that the sorting compartment can move linearly relative to the waste bin(s).

During operation, a circuit of the waste container processes sensor data to (i) determine that an item has been placed inside the sorting compartment 600 and (ii) determine that the item should be disposed of in a landfill. The waste bin for collecting landfill items is located to the right of the sorting compartment 600. The sorting compartment 600 rotates counterclockwise around the pivot member 618 to position the exit doors 604, 608 above the waste bin. The motors 610, 612 actuate the hinges 614, 616 to cause the exit doors 604, 608 to transition from their closed position to their open position, whereby the item is released or otherwise falls into the waste bin.

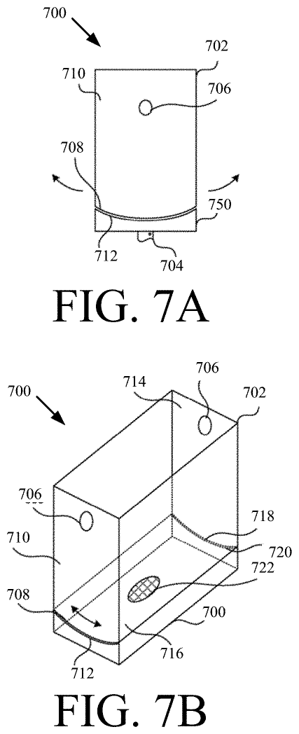

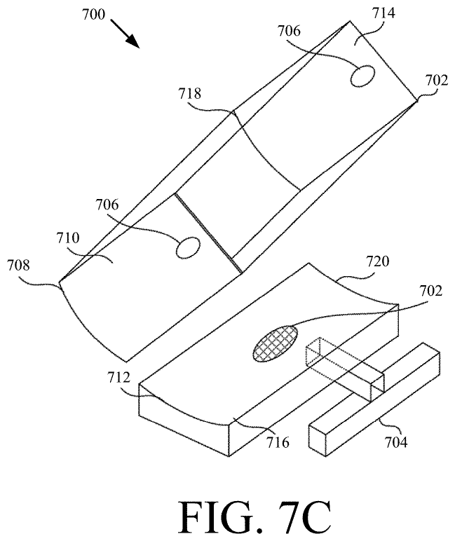

Referring now FIG. 7, there is provided illustrations of another sorting compartment 700. The sorting compartment 700 is disposed on top of a liquid collection compartment 750. The liquid collection compartment 750 is stationary, while the sorting compartment 750 is movable (e.g., rotatable above pivot member 706). The sorting compartment 700 does not have a bottom wall such that an item deposited therein will come to rest on a top surface 716 of the liquid collection compartment 750. A load sensor 704 can be attached to the liquid collection compartment 750 to measure the weight of the item as it rests on surface 716.

Surface 716 may be concave and have a drainage hole 722 formed therein. The drainage hole 722 may be located at the lowest point of the concave surface 716 so that any contents (e.g., liquid, powder, granulate or other substance) drains from the item into the liquid collection compartment 750 at least partially due to gravity. The bottom edges 708, 718 of the walls 710, 714 respectively follow the curvature of the edges 712, 720 associated with the concave surface 716. The sorting compartment 700 can rotate around the pivot 706 without rubbing against the edges 712, 720 associated with concave surface 716.

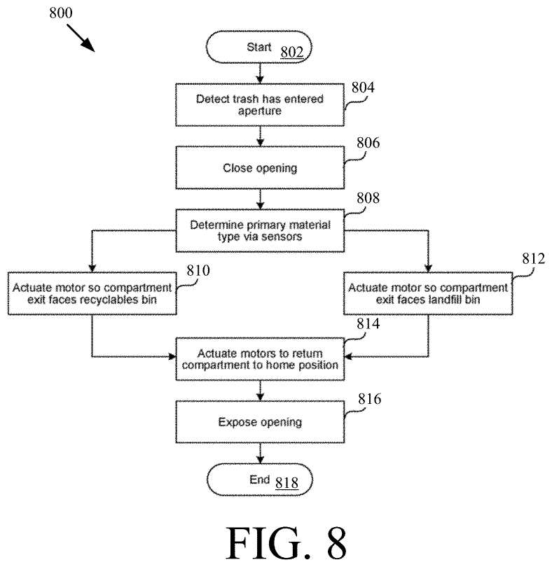

Referring now to FIG. 8, there is provided a flow diagram of an illustrative method 800 for processing waste or other items within a waste container (e.g., waste container 100 of FIG. 1). Method 800 begins with 802 and continues with 804 where a circuit (e.g., circuit 106 of FIG. 1) performs operations to detect when an item (e.g., item 500 of FIG. 5) has been received in the sorting compartment (e.g., sorting compartment 402 of FIG. 4, 600 of FIG. 6 or 700 of FIG. 7) of waste container. This detection can be made using sensor data generated by one or more sensors provided with the waste container. The sensor data can include, but is not limited to, image(s), video(s), beam break sensor data, motion sensor data, light detection sensor data, odor sensor data, and/or cover position sensor data. When such a detection is made, the circuit optionally performs operations to cause actuation of a safety mechanism of the waste container to secure the cover (e.g., cover 104 of FIG. 1) in a closed position for preventing an individual from interfering with or experiencing injury from the item's processing by the waste container. The safety mechanism can include, but is not limited to, a latch and/or a lock.

Next in 808, the circuit of the waste container performs operations to (i) determine a type of waste for the detected item based on sensor data and (ii) determine the type of material that the item comprises. The type of waste may include a recyclable type of waste or a non-recyclable type of waste. Recyclable waste includes any item that can be recycled (e.g., a metal can, a plastic object, a paper cup, a cardboard sheet, a piece of cloth, and/or a glass container). Non-recyclable waste may be subcategorized as a landfill type of waste, a compost type of waste, or other type of waste. If the type of waste is determined to be a recyclable type of waste, then a material category is determined for the item. The material category can include, but is not limited to, a plastic category, a paper category, a metal category and/or other recyclable material category. Each material category can have a subcategory. For example, a plastic category can be associated with a P1 plastic subcategory, a P2 plastic subcategory, etc. The paper category can be associated with an office paper subcategory, a cardboard subcategory, etc.

When a determination is made that the item is of a recyclable type, the circuit causes the sorting compartment to deposit the item into a certain waste bin (e.g., waste bin 406 or 408 of FIG. 4), as shown by 810. This deposition can be achieved via activation of a motor (e.g., motor 610 and/or 612 of FIG. 6) so that the sorting compartment releases the item into the waste bin provided for collecting recyclable items.

When a determination is made that the item is of a non-recyclable type, the circuit performs operations to cause activation of the motor so that the sorting compartment releases the item into the waste bin provided for collecting non-recyclable items or a sub-category of non-recyclable items (e.g., landfill types of items).

In step 814, the sorting compartment returns to its rest position or state. In step 816, the security mechanism is optionally actuated so that the cover is released/unlocked/unlatched and another item can be disposed in the waste container. Subsequently, 818 is performed where method 800 ends or other operations are performed (e.g., return to 804).

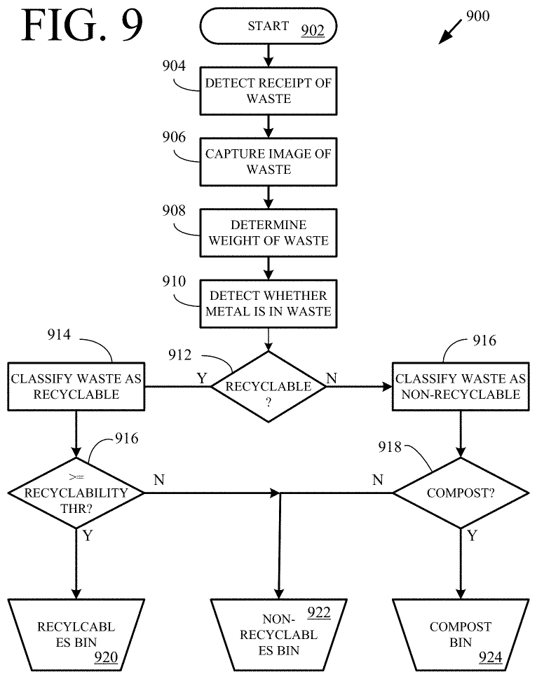

Referring now to FIG. 9, there is provided a flow diagram of a method 900 for automatically sorting waste by a sorting compartment (e.g., sorting compartment 402 of FIG. 4, 600 of FIG. 6, or 700 of FIG. 7). Method 900 begins with 902 and continues with 904 where sensor data is generated and used to detect the presence of an item in the sorting compartment. For example, a motion detection sensor may be employed to detect that an individual in proximate to the system, a position sensor may be employed to facilitate detection that someone has opened a cover (e.g., cover 104 of FIG. 1) of the system to place an item therein, and/or a load sensor may be employed to facilitate a detection that a weight has been received.

Two or more sensors will capture data points that the system will use (i) to assign a type of waste to the item and (ii) select a waste bin of a plurality of waste bins that is associated with the assigned type. For example, a camera may capture a digital image of the item placed within the waste container as shown by 906. A load sensor may weigh the item as shown by 908. A metal detector may be used in 910 to detect whether the item is made of metal, and if so what type of metal. The metal detector can include, but is not limited to, an inductance sensor and a capacitive sensor. Alternatively and/or additionally, one or more other sensors can be used to generate sensor data that is useful for determine a type of waste category for the item. These other sensors can include, but are not limited to, temperature sensors, infrared sensors, spectroscopy sensors, audio sensors, capacitive sensors, fluorescence sensors, millimeter-wave radar sensors, and/or depth cameras.

The system will perform comparison operations using the sensor data to identify a predefined data set to which the sensor data matches by a certain amount (e.g., 70%). Once a predefined data set has been identified, the system accesses a datastore to obtain a type of waste category associated therewith (e.g., a recyclable type of waste or a non-recyclable type of waste), as shown by 912. For example, if the first sensor is a camera that captured a digital image of the item, the system will perform image processing to determine whether content of the digital image corresponds to one or more characteristics of a known recyclable object. The image processing may be performed using any now or hereafter known image processing techniques, including but not limited to edge detection, object recognition, feature extraction, and other techniques. The characteristics of known recyclable objects may be stored in a data set that is accessible to the processor. Examples of characteristics of known objects that the data set may store include a logo (such as a product trademark), text of a known product name, a shape, a size and/or a color scheme.

If the content of the digital image corresponds to one or more characteristics of a known recyclable object specified in a data set [912:YES], then the system will classify the item as a recyclable type of waste in 914. Next, the sorting compartment either (i) deposits the time into a recyclable waste bin as shown by 920 or (ii) performs additional analysis in 918, 922, 924 which will be described below.

If the content of the digital image does not correspond to one or more characteristics of a known recyclable object, the system will classify the piece of waste as a non-recyclable type of waste as shown by 916. Next, the sorting compartment directs the item to a non-recyclable waste bin as shown by 922. Optionally, the system may analyze the sensed data to determine whether this material is compostable as shown by 918. If so [918:YES], the sorting compartment directs the item to a compostable waste bin in 924.

As another example, if one of the sensors in an inductance sensor (on its own or in combination with other sensors of a metal detector), the system may determine that the waste is formed of a recyclable material if the inductance sensor indicates that the piece of waste is metallic.

Instead of just one sensor, the system may analyzes the image produced by the camera, the weight measurement produced by the load sensor, and the inductance measured by the inductance sensor in combination to determine the type of waste, using any suitable algorithms, or comparison of the sensed data to characteristics of material types as stored in a data set.

In 912 or 916, if one of the sensors is a camera, to analyze the image produced by the camera, the system may use vision algorithms to produce a list of categories and a corresponding list of probabilities associated with the object. The system may utilize a machine learning method (e.g., a Bayesian Classification algorithm) which may compare the image or other captured sensor data against a trained data set to determine the probability that the item in the image represents a particular known item. For example, given an image, the vision algorithm may produce the list of categories: {a bottle, a cup, a stick, a ball} and the corresponding list of probabilities: {0.6, 0.3, 0.1, 0.2}. In this example, the list of probabilities indicates that the image is a bottle with the probability of 0.6, a cup with the probability of 0.3, a stick with the probability of 0.1 and a ball with the probability of 0.2. The present solution is not limited to the particulars of this example.

Before depositing a recyclable material into a recyclable waste bin, the system may use additional sensed data to determine whether the waste meets a recyclability threshold in 916. For example, if the classification operations determined that the piece of waste is a food or beverage container, the recyclability threshold may be a requirement that the container contain no more than a threshold amount of liquid or other material. The system may then determine the weight of the object and determine whether the weight meets or exceeds a threshold beyond which recyclability is not possible. As another example, if the classification operation determined that the piece of waste is a cardboard box, the system may use a sensor (such as a camera) to determine whether the box is a pizza box. If so, the sorting compartment can move the box to a non-recyclable waste bin based on a rule that pizza boxes are typically contaminated with food particles and thus expected to be non-recyclable.

The system also may take weight of the object into account when determining whether or not a particular piece of waste is recyclable in 912. For example, the system may store a table of weights and corresponding pieces of waste in a memory. The table may include information that landfill paper typically weighs in the range of 11 g-23 g, a metal can typically weighs in the range of 13 g-15 g, a plastic container typically weighs in the range of 14 g-19 g, etc. The weight categories can correspond to the categories produced by the vision algorithm, can be overlapping, or can be disjointed. Based on the weight of the piece of waste placed in the waste container, the system may assign a probability to each category.

The system can assign the probability to a category in various ways. If the weight falls into several categories, the system can evenly distribute the probability among the several categories. For example, if the weight of the piece of waste is 16 g, the system may determine that the probability that the piece of waste is a metal can is 0.0, the probability that the piece of waste is a plastic container is 0.5, and probability that the piece of waste is landfill paper is 0.5. Additionally or alternatively, the system assigns a greater probability the closer the measured weight is to the average weight associated with a particular category. For example, the average weight of the landfill paper is 17 g, the average weight of the metal can is 14 g, and the average weight of the plastic container is 16.5 g. The weight of the measured piece of waste is determined to be 16 g. Assigning probability based on the proximity to the average weight, the probability that the piece of waste is a metal can is 0, the probability that the piece of waste is a plastic container is (16 g−14 g)/(16.5 g−14 g)*0.5=0.4, and the probability that the piece of waste a landfill paper is (16 g−11 g)/(17 g−11 g)*0.5=0.417. Normalizing the two probabilities so that they add up to 1, the system may determine that the probability that the piece of waste is a plastic container is 0.49, while the probability that the piece of waste is a landfill paper is 0.51. The system may select the higher probability as the material to which the item will be classified. The present solution is not limited to the particulars of this example.

The system also may take inductance of the object into account when determining whether or not a particular piece of waste is recyclable in 912, or to determine the recyclability threshold in 916. To do this, the system may store a table of inductances and corresponding pieces of waste in the memory. The inductance for most materials is generally equal, approximately 137 H, except for pieces of trash containing metal, when the inductance varies within 140 H-154 H. Thus, in some scenarios, the recyclability threshold may be a particular inductance level (such as 140 H). Based on the measurement received, the system may assign a probability that the piece of waste is metal. Finally, the system combines the probabilities associated with various categories received from image analysis, weight analysis, and inductance analysis to determine the type of waste deposited in the waste container.

In the event that the system is unable to positively identify that a piece of waste is a particular type of waste with a predetermined level of certainty, the system may automatically divert the waste to a bin designated for landfill disposal. For example, if, after assigning probabilities that a piece of waste is formed of a particular material based on the various sensor input described above, the system still does not recognize the type of waste with at least 80% certainty, the system may divert the waste to a landfill bin. However, the actual waste-type recognition threshold needed to divert waste to a particular recycling bin is not limited to 80%, and may be customizable and/or adjustable within the processor based on recycling plant preferences, local regulations, etc.

In addition, the system can be connected to a database via a wired or a wireless network as described herein. The system may store, in a data set in computer-readable memory, information regarding the type of waste received. Further, the data set can associate the type of waste with an identifier (ID) associated with the waste. The system can also retrieve the information regarding the type of waste in the ID associated with the waste and output information and/or statistics to a user of the system on a display device or via an audio output, if the waste container is equipped with a display or speaker. Such information can be used in utilizing game mechanics to incentivize consuming items that lead to recyclable waste, educating material type in schools about what is recyclable and not, etc. For example, when two different waste containers are placed on two different floors in an office building, the processor can keep track of which floor discarded more recyclable waste, and award incentives, such as game points, to the floor that discarded more recyclable waste.

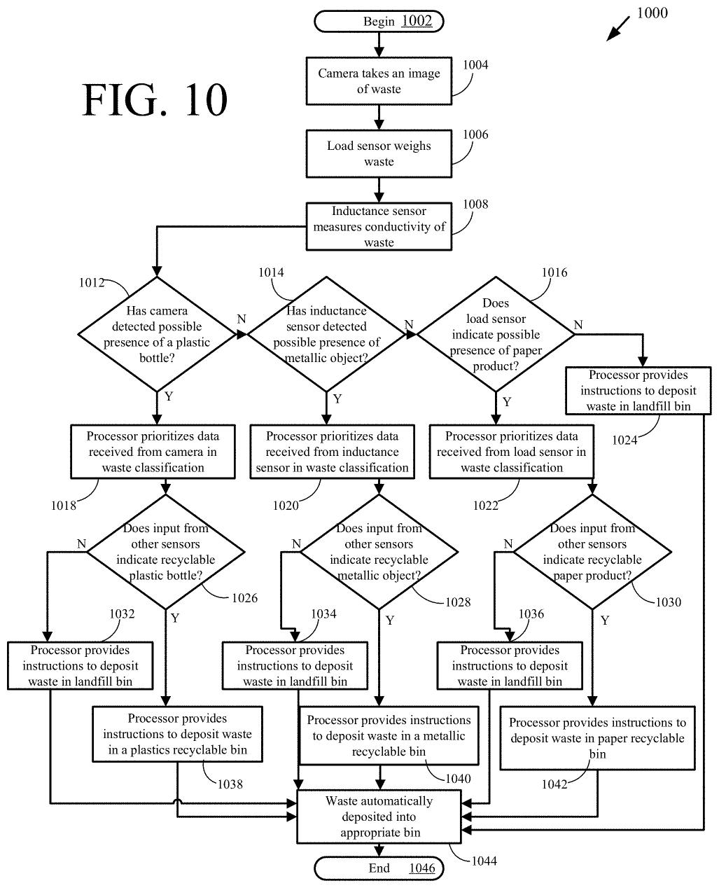

As noted above, circuit 106 is configured to assesses whether a piece of waste corresponds to a particular item (plastic bottle, metallic object, or paper product). Such an assessment can be performed in the manner discussed above in relation to FIGS. 8-9. While the method described above with respect to FIG. 9 details the utilization of multiple sensors working in conjunction to classify a piece of waste placed within a waste container and appropriately dispose of that waste, FIG. 10 details a method of determining a type of waste, again utilizing multiple different sensor inputs, but prioritizing classification based on particular sensor inputs.

Referring now to FIG. 10, method 1000 begins with 1002 and continues with 1004 where a camera takes an image of the piece of waste placed within the waste container. In 1006, a load sensor weighs the piece of waste. In step 1008, the inductance sensor measures conductivity of the piece of waste. It is to be understood that operations 1004-1008 may be performed in any order, and more than one of each applicable sensor may be utilized. Alternatively and/or additionally, one or more other sensors, such as temperature sensors, infrared sensors, spectroscopy sensors, audio sensors, capacitive sensors, fluorescence sensors, millimeter-wave radar sensors, depth cameras, etc., may be utilized in lieu of, or in addition to, one or more of a camera, load sensor, or inductance sensor.

In step 1012, it is determined, by a processor executing programming instructions, whether the camera has detected the possible presence of a plastic bottle. As described above, the system may utilize a machine learning method such as, for example, Bayesian Classification, which may compare the image captured by the camera against a trained data set to determine the probability that the item in the image represents a particular, known item, such as a plastic bottle. If yes [1012:YES], method continues with 1018 where the system prioritizes the data received from the camera in classifying the waste as recyclable or non-recyclable. That is, due to an increased relative confidence that an object captured in an image by the camera is (or is not) a plastic bottle, the system may be configured to weight the probability determinations related to the camera data more heavily than data received from other sensors (e.g., load sensor(s), inductance sensor(s), etc.). As most plastic bottles are formed of one of a variety of known shapes, sizes, and/or colors, the data received from the camera is more likely the most accurate in determining the type of object.

However, if no [1012:NO] then the method continues with 1014 where the system determines whether the inductance sensor has detected the possible presence of a metallic object (e.g., an aluminum beverage can). Again, a machine learning method may be used to compare conductivity data captured by the inductance sensor against a trained data set to determine the probability that an object having a particular conductivity represents a known item, such as, e.g., an aluminum beverage can. If yes [1014:YES], the method continues with 1020 where the system prioritizes data received from the induction sensor in classifying the waste as recyclable or non-recyclable. In this case, if the inductance sensor indicates the presence of a metallic object, there is an increased confidence that the detected object may be a recyclable metallic object (e.g., a beverage can). Thus, the processor may be configured to weigh the probability determinations related to the conductivity data more heavily than data received from other sensors, as a metallic object may be more readily and positively identifiable by an inductance sensor than, for example, a camera or load sensor.

However, if not [1014:NO], then the method continues with 1016 wherein the system may determine whether the load sensor indicates the possible presence of a recyclable paper product. As described above, paper products typically fall within a specific weight range (e.g., 11 g-23 g), such that the data received from the load sensor may be used to determine if an object that is not a plastic bottle and is not a metallic object may be a paper product. If yes [1016:YES], then the system may prioritize data received from the load sensor in classifying the waste as recyclable or non-recyclable as shown by 1022. In this case, if the load sensor indicates the possible presence of a paper product, there is an increased confidence that the detected object may be a recyclable product, such as corrugated cardboard or office paper. Thus, the processor may be configured to weigh the probability determinations related to the weight data more heavily than data received from other sensors, as a paper product may be more readily and positively identifiable by a load sensor than, for example, a camera or inductance sensor.

While steps 1004-1006 are described using a camera, inductance sensor, and load sensor respectively and in that order, it is again to be understood that the steps may be performed in any order, and the determination steps 1012-1016 may similarly be determined in any order. Also, while a camera, inductance sensor, and load sensor are described in the method set forth in FIG. 10, one or more other sensors, such as temperature sensors, infrared sensors, spectroscopy sensors, audio sensors, capacitive sensors, fluorescence sensors, millimeter-wave radar sensors, depth cameras, etc., may be utilized in lieu of, or in addition to, one or more of a camera, load sensor, or inductance sensor, and the processor may prioritize data received from any one of the above sensors based on relative confidence in a given sensors' accuracy in determining the presence of a particular object.

If the camera does not detect the possible presence of a plastic bottle, the inductance sensor does not detect the possible presence of a metallic object, and the load sensor does not indicate the possible presence of a paper product, in step 1024, the system may execute instructions to deposit the inserted waste into a bin designated for landfill waste. Such instructions are made based on the fact that none of the sensors utilized determined that the inserted object may contain (at least partially) a recyclable material. Once again, other sensors may be utilized in lieu of, or in addition to, one or more of a camera, load sensor, or inductance sensor, in making the determination if a recyclable product is potentially present.

Referring again to block 1018, while the system prioritizes data received from the camera if the presence of a plastic bottle is determined, the system may also utilize input from other sensors (e.g., a load sensor, millimeter-wave radar sensor, etc.) in decision block 1026 to determine not only if the object is indeed a plastic bottle, but also if the plastic bottle is recyclable. That is, secondary sensor input from, for example, a load sensor, may indicate that the plastic bottle weighs more than a known threshold range of substantially empty, recyclable plastic bottles, as determined from the trained data set accessed by the processor. A plastic bottle weighing more than a known threshold range may indicate that the bottle still contains liquid. Depending upon local regulations, a plastic bottle containing more than a predetermined amount of liquid (including water) may be considered contaminated and, therefore, unrecyclable. Thus, if the determination from the secondary sensor data suggests that yes, a recyclable plastic bottle is detected, then the processor may provide instructions to deposit the waste in a plastics recyclable bin in step 1038, and the waste is automatically deposited into an appropriate bin at step 1044. However, if the secondary sensor data suggest that no, the plastic bottle detected by the camera is not recyclable (e.g., due to contamination, etc.), then the processor may provide instructions to deposit the waste in a landfill bin at step 1032, and the waste is automatically deposited into an appropriate bin at step 1044.

Similarly, referring again to step 1020, the system may prioritize data received from the inductance sensor if the presence of a metallic object is detected, but in step 1028, the processor also utilizes input from other sensors (e.g., a camera, a load sensor, etc.) to determine not only if the object contains a metallic material, but if that metallic object is recyclable. As with the example above regarding the plastic bottle, secondary sensor input from, for example, a load sensor, may indicate that the metallic object (e.g., an aluminum beverage can) still contains liquid therein and is, therefore, too contaminated to be properly recycled according to local regulations. Thus, if the determination from the secondary sensor data suggests that yes, a recyclable metallic object is detected, then the processor may provide instructions to deposit the waste in a metallic recyclable bin in step 1040, and the waste is automatically deposited into an appropriate bin at step 1044. However, if the secondary sensor data suggest that the answer to the “is it recyclable” question is no, the metallic object detected by the inductance sensor is not recyclable (e.g., due to contamination, etc.), then the processor may provide instructions to deposit the waste in a landfill bin at step 1034, and the waste is automatically deposited into an appropriate bin at step 1044.

Referring once again to step 1022, the processor may prioritize data received from the load sensor if the presence of a paper product or object is detected, but in step 1030, the processor also utilizes input from other sensors (e.g., a camera, a millimeter-wave radar sensor, etc.) to determine not only if the object is made of paper, but if paper itself is recyclable. For example, secondary sensor input from a camera or millimeter-wave radar sensor may indicate that paper product may be too contaminated to be properly recycled according to local regulations. For example, while a corrugated box may typically be recyclable, a corrugated box having food or grease contamination on any surface thereof may not be recyclable. Thus, if the determination from the secondary sensor data suggests that yes, a recyclable paper product is detected, then the processor may provide instructions to deposit the waste in a paper recyclable bin in block 1042, and the waste is automatically deposited into an appropriate bin at step 1044. However, if the secondary sensor data suggest that no, the paper product detected by the load sensor is not recyclable (e.g., due to food contamination, etc.), then the processor may provide instructions to deposit the waste in a landfill bin at step 1036, and the waste is automatically deposited into an appropriate bin at step 1044.

While the method described above with respect to FIG. 10 details steps in which an object is both identified and its recyclability determined, it is to be noted that the standards of what is and is not acceptable as a recyclable material are often set by a local jurisdiction and/or recycling plant facility. Accordingly, the thresholds used by the processor to determine whether or not an object is recyclable may be dynamically adjusted based upon local codes and preferences at the location of the waste container. For example, one recycling plant may accept plastic bottles with up to one ounce of liquid still contained therein, whereas a recycling plant in another location may not accept plastic bottles with any liquid remaining therein. In accordance with aspects of the disclosure, such thresholds may be dynamically programmed into the processor to provide for location-specific sorting.

Similarly, different localities may restrict the types of materials which can be recycled. For example, some locations allow for all plastics to be recycled, while others restrict recycling to Type 1, 2, 4, and 6 plastics. Accordingly, in areas where only Type 1, 2, 4, and 6 plastics are deemed recyclable, the processor may be programmed to determine (via a variety of sensors, as described above) the type of plastics and sort accordingly. If, in the future, other types of plastic are considered recyclable in that area, the system can be locally or remotely updated to allow for such sorting.

In addition to the various types of sensors used in classifying and/or identifying the various pieces of waste inserted into the waste container, one or more additional sensors may be present within the waste container so as to determine the fullness and/or remaining capacity of one or more of the waste bins therein. For example, one or more sonar sensors or infrared sensors may be utilized within the waste container to determine the relative fullness and/or remaining capacity of one or more of the bins. The waste container may have an external indicator, such as a visual and/or audible indicator, which notifies a user or responsible party that a particular waste bin is at or near capacity and should therefore be emptied. For example, one or more light-emitting diodes or other visual indicators viewable directly at the waste container may be illuminated when a waste bin is at or near capacity. Alternatively and/or additionally, a graphical user interface located on the waste bin itself may provide a visual and/or audible indication that a waste bin is full, or a user interface on a web-enabled device (e.g., a smartphone, tablet computer, etc.) in communication with the waste container may provide a similar visual and/or audible indication that a waste bin is full.

In accordance with another embodiment, the waste bin may comprise a display or user interface thereon which may provide, for example, instructions on proper disposal of waste, information on what is (or is not) considered recyclable waste, advertisements, etc. In one aspect, in the event that a piece of waste of determined not to be recyclable due to contamination or other reasons, the display or user interface may provide an indication to the user as to why the waste was placed in a landfill waste bin as opposed to a recyclable waste bin. For example, if the user places a plastic bottle into the waste bin that is still filled with an impermissible amount of liquid, the display or user interface may provide visual and/or audible feedback to the user, explaining why the plastic bottle was not recyclable. Furthermore, the display or user interface may provide the user with one or more recommendations as to how to properly dispose of the waste in the future (e.g., “Please empty all liquids from plastic container prior to disposal”). Alternatively and/or additionally, the display or user interface may not be located on the waste bin itself, but may instead be located on a web-enabled device (e.g., a smartphone, tablet computer, etc.) in communication with the waste container.

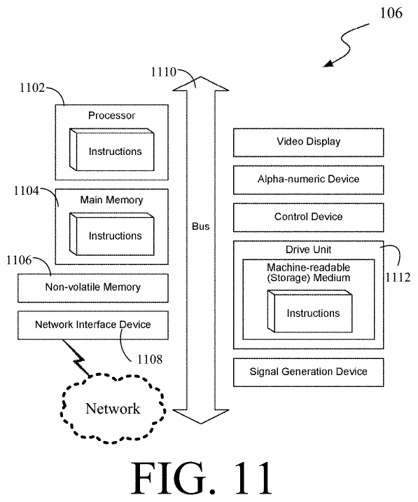

Referring now to FIG. 11, there is provided a more detailed block diagram for the circuit 106 of the waster container. Circuit 106 may comprise a machine in the example form of a computer system 800 within which a set of instructions, for causing the machine to perform any one or more of the methodologies or modules discussed herein, may be executed.

The circuit 106 can include elements such as a processor 1102, a main memory 1104, a non-volatile memory 1106, and an interface device 1108. Various common components (e.g., cache memory) are omitted for illustrative simplicity. The circuit 106 is intended to illustrate a hardware device on which any of the components and/or methods described (and any other components described in this specification) can be implemented. The circuit 106 can be of any applicable known or convenient type. The components of the circuit 106 can be coupled together via a bus or through some other known or convenient device.

This disclosure contemplates the circuit 106 taking any suitable physical form. As example and not by way of limitation, circuit 106 may be an embedded computer system, a System-On-Chip (SOC), a Single-Board Computer (SBC) system (e.g., a Computer-On-Module (COM) or a System-On-Module (SOM)), a desktop computer system, a laptop or notebook computer system, an interactive kiosk, a mainframe, a mesh of computer systems, a mobile telephone, a Personal Digital Assistant (PDA), a Server, or a combination of two or more of these. Where appropriate, circuit 106 may include one or more computer systems; be unitary or distributed; span multiple locations; span multiple machines; or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

A bus 1010 also couples the processor 1102 to the non-volatile memory 1106 and drive unit 1112. The non-volatile memory 1106 is often a magnetic floppy or hard disk, a magnetic-optical disk, an optical disk, a Read-Only Memory (ROM), such as a CD-ROM, EPROM, or EEPROM, a magnetic or optical card, or another form of storage for large amounts of data. Some of this data is often written, by a direct memory access process, into memory during execution of software in the circuit. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Programming instructions are typically stored in the non-volatile memory and/or the drive unit. Indeed, storing an entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor 1102 to the network interface device 1106. The network interface device 1106 can include one or more of a modem or network interface. It will be appreciated that a modem or network interface can be considered to be part of the circuit. The interface can include an analog modem, ISDN modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a Cathode Ray Tube (CRT), Liquid Crystal Display (LCD), or some other applicable known or convenient display device. For simplicity, it is assumed that controllers of any devices not depicted in the example of FIG. 11 reside in the interface.

In operation, the circuit can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the nonvolatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that he disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

Illustrative Systems

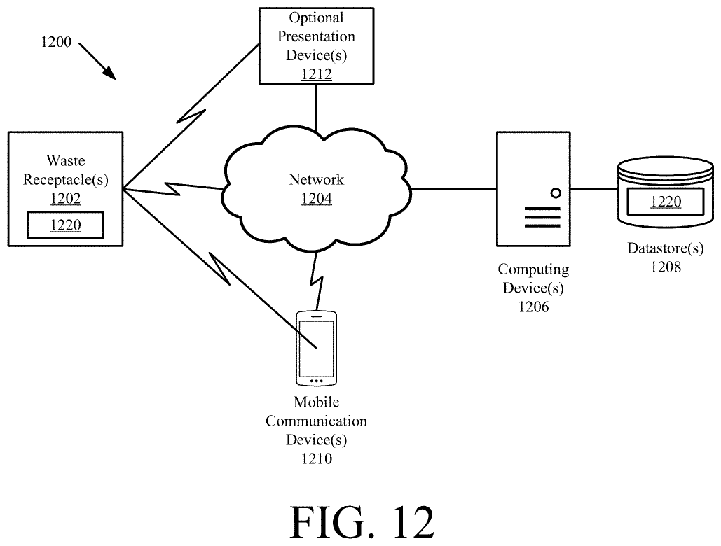

Referring now to FIG. 12, there is provided an illustration of a waste collection system 1200 implementing interactive presentation features. System 1200 comprises waste receptacle(s) 1202, computing device(s) 1206, datastore(s) 1208, mobile communication device(s) 1210 and optional presentation device(s) 1212. The listed components 1202, 1206, 1210 and/or 1212 can communicate with each other via wired communications or wireless communications across network 1204. Any communication technology can be used to facilitate such wired and/or wireless communications. Network 1204 can include, but is not limited to, the Internet, a LAN, a WAN, a cellular network and/or a radio network.

Waste receptacle(s) can include waste container 100 of FIG. 1. As discussed above, waste container 100 comprises (i) an opening 102 through which items can be disposed by individuals and (ii) a circuit 106 configured to detect characteristic(s) of the items deposited through the opening 102 and into the sorting compartment (e.g., sorting compartment 402 of FIG. 4, 600 of FIG. 6 or 700 of FIG. 7). The detected characteristic(s) can be used for various purposes such as providing individuals with feedback prior to, during and/or after depositing item(s) into the waste receptacle(s). The feedback can include, but is not limited to, auditory feedback (e.g., a sound, a song and/or speech), visual feedback (e.g., image(s), video(s) and/or a light show) and/or tactile feedback (e.g., vibration of an electronic device). Each of the listed types of feedback is defined or otherwise specified in a library 1220 that is accessible to the waste receptacle(s).

The library 1220 can be stored in the datastore 1208 and/or in memory (e.g., main memory 1104 of FIG. 1) of the waste receptacle(s) 1202. The library 1220 can include, but is not limited to, media content stored in association with pre-defined tags and/or other information. The media content can include audio (e.g., a sound, a song and/or speech), image(s), video(s), advertisement(s), graphic(s), icon(s), instructions for light show(s), and/or instructions for providing tactile feedback (e.g., a single vibration or a series of vibrations). The pre-defined tags provide a means to search the library 1220 for media content associated with item(s) proximate to (e.g., outside of but in close distance to) or inside of waste receptacle(s). The pre-defined tags can specify an item type (e.g., a bottle, a plate, a piece of silverware, a straw, a box, a newspaper, a magazine, a shirt, etc.), a waste type (e.g., recyclable or non-recyclable), item material(s) (e.g., glass, plastic, paper, cardboard and/or cloth), a manufacturer (e.g., the Coca-Cola Company), a product name (e.g., Coca-Cola Soft drink), a product code or identifier (e.g., a barcode, a unique product code, trademark, etc.), a manufacturer, an item marking (e.g., a trademark, a slogan, a label design), an item shape, an item size, item color(s), and/or item contents (e.g., liquid, solid, powder, perishable food, hazardous liquid chemical, etc.). The other information can include, but is not limited to, demographics of individuals that use and/or purchase items, popularities of items, geographic areas where items are typically used or purchased, and/or manners in which items are used (e.g., consumption, power source for electronic devices, food storage, entertainment, etc.).

The media content can be selectively output from the waste receptacle(s) 1202, mobile communication device(s) 1210 and/or presentation device(s) 1212 based on sensor data generated by sensor(s) of the waste receptacle(s). The manner in which the media content is selectively output will become evident as the discussion progresses. The presentation device(s) 1212 can include, but are not limited to, display(s), speaker(s) and/or a light system (e.g., an LED panel and/or laser light system). The presentation device(s) 1212 can be mounted on a wall or otherwise placed near the waste receptacle(s) 1202. The mobile communication device(s) 1210 can be in the possession of individual(s) in proximity to the waste receptacle(s) 1202. The mobile communication device(s) 1210 can include, but are not limited to, smart phones, smart watches, personal computers, personal digital assistants, and/or tablets.

During operation, sensor(s) (e.g., sensor(s) 108 of FIG. 1) of the waste receptacle(s) 1202 perform operations to generate sensor data specifying characteristic(s) of item(s) in proximity to (e.g., outside of) and/or disposed in the waste receptacle(s) 1202. The sensor data can also specify characteristics of the individual who is or was in possession of the item(s) prior to being disposed in the waste receptacle(s) 1202. The sensor data can include, but is not limited to, image(s), video(s), audio signal(s), odor identifier(s), temperature(s), weight(s), size(s), shape(s), color(s), marking(s), barcode information, condition(s) (e.g., empty, full, damaged, cap on, cap off, etc.), item distance(s) from waste receptacle(s), item location(s) relative to a reference location (e.g., the location of a waste receptacle 1202 or presentation device 1212), item movement(s), location(s) of individual(s) relative to the waste receptacle(s), position of individuals relative to a reference object (e.g., the individual is or is not facing a waste receptacle 1202 or presentation 1212), movement of individuals (e.g., an individual's path of travel is towards, passing or away from the waste receptacle), and/or mobile communication device identifier(s).

A circuit (e.g., circuit 106 of FIG. 1) of the waste receptacle(s) 1202 and/or another device (e.g., computing device(s) 1206) receive and process the sensor data to determine or otherwise obtain item-based information. The item-based information can include, but is not limited to: (1) the type of item (e.g., a bottle, a can, a pizza box, etc.), (2) the type of waste that the item(s) comprises (e.g., recyclable or non-recyclable), (3) characteristics of the item (e.g., size, weight, shape, color(s), etc.) (4) a condition of the item (e.g., empty, partially full, full, damaged, etc.), (5) a manufacturer of the item, (6) a tradename for the item, (7) a product identifier for the item, (8) label information for the item (e.g., a price), and/or (9) other information associated with the item (e.g., contents of the item (e.g., a liquid, a solid, a powder, a hazardous liquid chemical)). Individual-based information can also be obtained using the sensor data. The individual-based information can include, but is not limited to, an identifier for the individual (e.g., a Media Access Control (MAC) address for a mobile communication device in the possession of the individual), information indicting the popularity of the item type amongst individuals, and/or information indicating an average number of items of the same or similar type that has historically been processed by system 1200 during a given time of day (e.g., breakfast time, lunch time, dinner time, etc.) or year (e.g., a holiday season). The MAC address can be used to obtain social media content associated with the individual in possession of the mobile communication device (e.g., indicating the individual's likes and dislikes for products) and/or item popularity in a group to which the individual belongs (e.g., an age group, a country group, etc.).

The system can obtain the item-based information and/or the individual-based information utilizing one or more computer vision algorithms including: object detection, image classification, semantic segmentation, or object recognition. For example, the system may use deep learning and random forest models to create the classifier algorithm, but other classifiers can be used within the scope of the invention. These computer vision algorithms are trained by utilizing an existing data set of characteristics that are processed through statistical means to create a model that can predict characteristics of items in novel images.

The circuit of the waste receptacle(s) 1202 and/or the another device (e.g., computing device(s) 1206) then access(es) and search(es) the library 1220 using the item-based information. The library 1220 is searched to identify media content (e.g., a sound, a song, an image, a video, a light pattern, a vibration pattern, etc.) that is associated with the item-based information (e.g., a given type of item, a given type of waste, given item characteristics, given item condition(s), a given manufacturer, a given tradename, a given product identifier, given label information (e.g., price range), given item content(s), and/or other information).

The identified media content is then retrieved from the datastore 1208 and/or local memory of the waste receptacle(s) 1202. The media content is then caused to be output from the waste receptacle(s) 1202, mobile communication device(s) 1210 and/or presentation device(s) 1212. For example, image(s)/video(s)/advertisement(s) is(are) displayed on a display (e.g., display 200 of FIG. 2) of the waste receptacle(s) 1202, a display of the mobile communication device(s) 1210 in proximity to the waste receptacle(s) 1202, and/or a display of the presentation device(s) 1212 in proximity to the waste receptacle(s) 1202. Audio may also be output from speaker(s) of the devices 1202, 1210 and/or 1212. Light may also be output from the devices 1202, 1210 and/or 1212. The present solution is not limited to the particulars of this example. In some scenarios, the identified media content is streamed from the datastore 1208 to devices 1202, 1210 and/or 1212.

If no media content is identified as being associated with item(s), then the system can select media content in accordance with the individual-based information (e.g., the item's relationship to other products/items liked or disliked by the individual as indicated, for example, by social media posts) and/or other information (e.g., a time of day, a geographic location of the waste receptacle, a total number of individuals detected in proximity to the waste receptacle at a given time, sizes of all individuals detected in proximity to the waste receptacle (e.g., indicating a child and/or an adult), types of electronic devices in the possession of the proximate individuals (e.g., smart phone, smart watch, tablet, portable e-book reader device, a portable gaming device, etc.), a given degree of the item(s) popularity amongst individuals with or without a common attribute of the individual, an average number of such items processed by the system, etc.). The other criteria can be obtained (i) using clocks, (ii) counters, and/or (ii) wireless communications (e.g., Bluetooth communications or beacon signals) between waste receptacle(s) and electronic devices in proximity thereto.

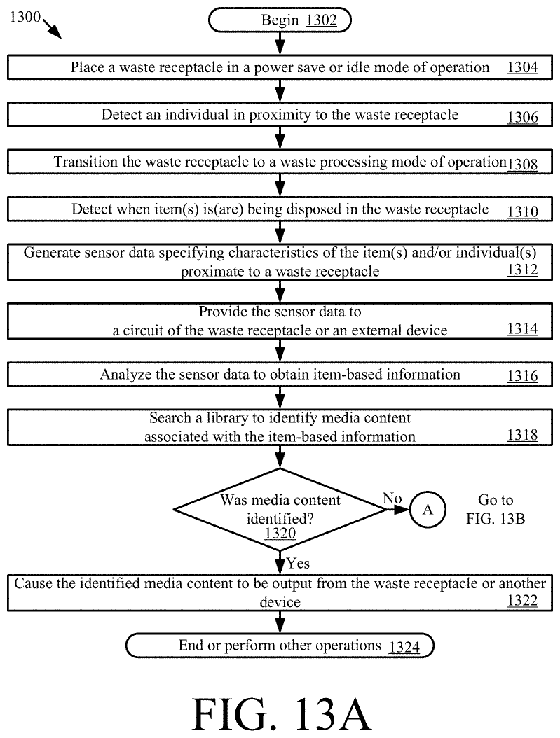

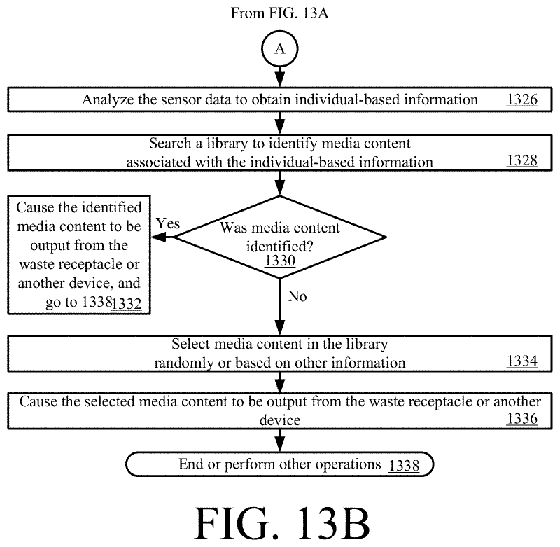

Referring now to FIG. 13, there is provided a flow diagram of an illustrative method 1300 for operating a system (e.g., system 1200 of FIG. 12). Method 1300 begins with 1302 and continues with 1304 where a waste receptacle (e.g., waste receptacle 1202 of FIG. 12) is placed in a power save mode operation or an idle mode of operation. In both of these modes of operation, sensor(s) of the waste receptacle can detect when an individual is in proximity thereto (e.g., within 10 feet thereof), as shown by 1306. The sensor(s) can include, but are not limited to, camera(s), proximity sensor(s) (e.g., beam brake sensor) and/or wireless communication device(s) that communicate with external devices (e.g., mobile communication device(s) 1210 of FIG. 12).

When such a detection is made, the waste receptacle transitions to a waste processing mode of operation in 1308. In the waste processing mode of operation, sensor(s) of the waste receptacle detect when item(s) is(are) proximate to and/or being disposed in the waste receptacle as shown by 1310 and generate sensor data specifying characteristic(s) of the item(s) and/or individual(s) proximate to the waste receptacle (e.g., within 10 feet of the waste receptacle) as shown by 1312. The individual(s) can include (i) those that have or had possession of the item(s) and/or (ii) others who do or did not have possession of the item(s). The sensor data is provided in 1314 to a circuit (e.g., circuit 106 of FIG. 6) of the waste receptacle and/or to an external device (e.g., computing device 1206 of FIG. 12).

The sensor data is analyzed in 1316 to obtain item-based information. The item-based information can include, but is not limited to, (1) the type of item (e.g., a bottle, a can, a pizza box, etc.), (2) the type of waste that the item(s) comprises (e.g., recyclable or non-recyclable), (3) characteristics of the item (e.g., size, weight, shape, color(s), etc.) (4) a condition of the item (e.g., empty, partially full, full, damaged, etc.), (5) a manufacturer of the item, (6) a tradename for the item, (7) a product identifier for the item, (8) label information for the item (e.g., a price), and/or (9) other information associated with the item (e.g., contents of the item (e.g., a liquid, a solid, a powder, a hazardous liquid chemical)).

In some scenarios, the item-based information is obtained for two or more items that were disposed in the waste receptacle within a threshold period of time starting from the time a first one of the items was detected by the waste receptacle (e.g., within 1 minute of each other). The two sets of item-based information are used to generate or otherwise obtain additional item-based information. The additional item-based information includes, but is not limited to, item classification(s), an identifier for a group to which both items belong, a common source identifier for both items (e.g., a given store, manufacturer or distributor), a ranking for the items relative to each other; an importance of the items relative to each other, and/or a value computed using weights selected for the items based on characteristic(s) thereof.

The item-based information is used in 1318 to search a library (e.g., library 1220 of FIG. 12) to identify media content associated therewith. The media content can be identified when the item-based information matches (e.g., by a certain degree or amount) a pre-defined tag associated with the media content. If media content was identified [1320:YES], then the media content is output (e.g., streamed) in 1322 from the waste receptacle or another device (e.g., mobile communication device 1210 and/or presentation device 1212 of FIG. 12). Subsequently, 1324 is performed where method 1300 ends or other operations are performed (e.g., return to 1302).

If media content was not identified [1320:NO], then method 1300 continues with 1326 of FIG. 13B. 1326 involves analyzing the sensor data to obtain individual-based information. The individual-based information can include, but is not limited to, an identifier for the individual (e.g., a MAC address for a mobile communication device in the possession of the individual), information indicting the popularity of the item type amongst individuals, and/or information indicating an average number of items of the same or similar type that has historically been processed by waste receptacle during a given time of day (e.g., breakfast time, lunch time, dinner time, etc.) or year (e.g., a holiday season). The MAC address can be used to obtain social media content associated with the individual in possession of the mobile communication device (e.g., indicating the individual's likes and dislikes for products) and/or item popularity in a group to which the individual belongs (e.g., an age group, a country group, etc.).

Next in 1328, the library is searched using the individual-based information. If media content was identified during this search [1330:YES], then the media content is output from the waste receptacle or another device (e.g., mobile communication device 1210 and/or presentation device 1212 of FIG. 12). Subsequently, 1338 is performed where method 1300 ends or other operations are performed (e.g., return to 1302).

If media content was not identified during this search [1330:NO], then media content is selected in 1334 randomly from the library or based on other information (e.g., a time of day, a geographic location of the waste receptacle, a total number of individuals detected in proximity to the waste receptacle at a given time, sizes of all individuals detected in proximity to the waste receptacle (e.g., indicating a child and/or an adult), types of electronic devices in the possession of the proximate individuals (e.g., smart phone, smart watch, tablet, portable e-book reader device, a portable gaming device, etc.), a given degree of the item(s) popularity amongst individuals with or without a common attribute of the individual, an average number of such items processed by the system, etc.). The selected media content is then output from waste receptacle or another device (e.g., mobile communication device 1210 and/or presentation device 1212 of FIG. 12) as shown by 1336. Subsequently, 1336 is performed where method 1300 ends or other operations are performed (e.g., return to 1302).

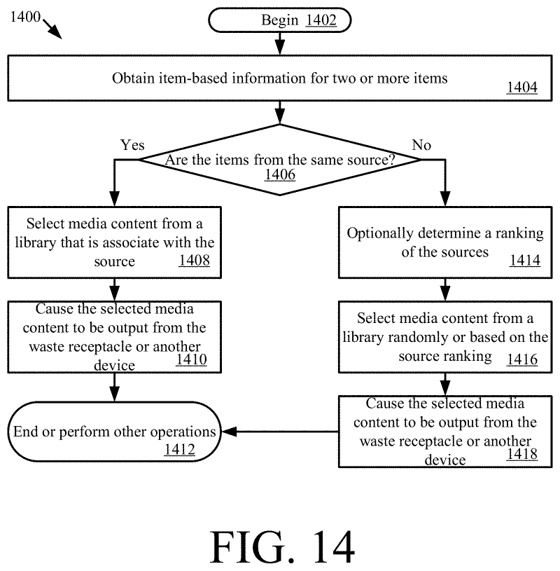

Referring now to FIG. 14, there is provided a flow diagram of another illustrative method 1400 for operating a system (e.g., system 1200 of FIG. 12). Method 1400 begins with 1402 and continues with 1404 where item-based information is obtained for two or more items. These items can include those that were disposed in a waste receptacle (e.g., waste receptacle 1202 of FIG. 2) within a threshold period of each other or those that are both in proximity to the waste receptacle at the same time.

If the item-based information indicates that the items are from the same source [1406:YES], then method 1400 continues with 1408-1410. 1408-1410 involve: selecting media content from a library (e.g., library 1220 of FIG. 12) that is associated with the common source; and causing the selected media content to be output from waste receptacle or another device (e.g., mobile communication device 1210 and/or presentation device 1212 of FIG. 12). Subsequently, 1412 is performed where method 1400 ends or other operations are performed (e.g., return to 1402).

If the item-based information indicates that the items are from different sources [1406:YES], then method 1400 continues with 1414-1418. 1414-1418 involve: optionally determining a ranking of the sources; selecting media content from a library (e.g., library 1220 of FIG. 12) randomly or based on the source ranking; and causing the selected media content to be output from waste receptacle or another device (e.g., mobile communication device 1210 and/or presentation device 1212 of FIG. 12). Subsequently, 1412 is performed where method 1400 ends or other operations are performed (e.g., return to 1402).

In some scenarios, an individual may approach a waste receiving container and deposit a beverage can. The lid closes, and the sensors capture data (e.g., an image) about the object and sends the information to a cloud server hosting a computer vision algorithm that is trained to detect the logos of brand name consumer product goods and return a value with the brand name. The computer vision algorithm processes the data received and returns a label for the item. The label may be a specific label, such as a value with the beverage company's brand name, or a general category such as beverage can. The system may then select a digital media file containing content that corresponds to the identified label by utilizing a script that, when run by the circuit of the waste container or a remote server, searches through a library database, hosted either locally or in the cloud. In the library, each piece of media is associated with one or more tags that are related to potential discarded object characteristics such as brand names, object materials, object types (aluminum cans, plastic bottles, glass bottles etc.). As the system running the scripts searches through this library, it will compare the initial output value of the label to these tags attached to the media, when the algorithm finds a piece of media with a related tag of the identified label it will trigger the system to play that piece of media content. The tag may be specific to a brand (e.g., media may be tagged as candidates for presentation if a Coke can is detected), or it may be associated with a category (such as non-alcoholic beverage cans). Any content item may be associated with multiple tags. The system may then play the digital file and output the file's content via the presentation device by streaming the media from a cloud server or playing the media from a local device. For example, if the digital media file picked by running the script is an advertisement for a beverage product, the system may display an image for the beverage product.

In those or other scenarios, an individual may deposit a coffee cup into a waste container. The system will recognize the object as a coffee cup using methods such as those described above. The system may then select a media file from the library that includes content about the recyclability of coffee cups appears. This information can include whether the object is recyclable or not, if it needs to be cleaned before being tossed, and common waste statistics. The system may output the content via the display or other presentation device.

The system may use additional rules to determine which media content to present to the consumer. For example, the system may implement a multi-step process that considers not only a single discarded items, but multiple items that are discarded within a short threshold period of time from each other (for example, within 10 seconds, 20 seconds, or 30 seconds of each other). The system may identify each contemporaneously discarded item and, determine whether the items are collectively associated with a “group label” or category. If so, then the system may select and present media content having a tag that is relevant to the group label. For example, if the system sees a contemporaneously discarded wet wipe and diaper, it may presume that the wipe was related to the diaper, and that the group label may be “parent with baby.” As another example, if the system sees a crumpled food wrapper but cannot detect a logo on the wrapper, along with a contemporaneously discarded drink cup with a fast food restaurant's logo on it, the system may presume that both items may be associated with a group label for the fast food restaurant (or with fast food restaurants in general).

The system may use other systems to detect whether multiple objects were discarded by the same person. An example may include a beacon or other wireless system that detects an identifier of mobile electronic devices (such as mobile phones) that are proximate to the waste receptacle. For example, if only one electronic device is detected during a time period in which multiple items were discarded, the system may presume that the items are related and were discarded by the same individual.

In those or other scenarios, when identifying content to present in response to detecting discarded items, multiple media content items may have tags that are associated with the discarded item(s) label(s). If this happens, the system may use any suitable process to select content from the candidate media content items. Such processes may include applying a randomization algorithm, optionally in which weights are applied to that certain content items have a greater likelihood of being selected. For example, a content item that is most recent, or a content item for whom the advertiser paid a premium, may be given greater weight. Other examples may include a rank order (i.e., play the item that is next in a queue), or it may apply additional factors to the algorithm such as an amount of time since an item has been previously played, exclusionary factors (such as only play certain content items at certain days or times), or other criteria.

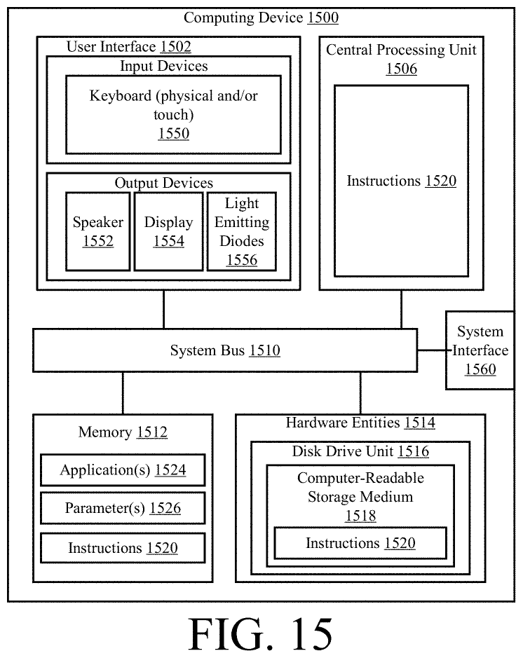

Referring now to FIG. 15, there is provided an illustration of an illustrative architecture for a computing device 1500. The waste receptable(s) 1202, computing device(s) 1206, mobile computing device(s) 1210 and/or presentation device(s) 1212 of FIG. 12 is/are the same as or similar to computing device 1500. As such, the discussion of computing device 1500 is sufficient for understanding the c device 1202, 1206, 1210, 1212 of FIG. 12.

Computing device 1500 may include more or less components than those shown in FIG. 15. However, the components shown are sufficient to disclose an illustrative solution implementing the present solution. The hardware architecture of FIG. 15 represents one implementation of a representative computing device configured to operate a vehicle, as described herein. As such, the computing device 1500 of FIG. 15 implements at least a portion of the method(s) described herein.

Some or all components of the computing device 1500 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 15, the computing device 1500 comprises a user interface 1502, a Central Processing Unit (CPU) 1506, a system bus 1510, a memory 1512 connected to and accessible by other portions of computing device 1500 through system bus 1510, a system interface 1560, and hardware entities 1514 connected to system bus 1510. The user interface can include input devices and output devices, which facilitate user-software interactions for controlling operations of the computing device 1500. The input devices include, but are not limited to, a physical and/or touch keyboard 1550. The input devices can be connected to the computing device 1500 via a wired or wireless connection (e.g., a Bluetooth® connection). The output devices include, but are not limited to, a speaker 1552, a display 1554, and/or light emitting diodes 1556. System interface 1560 is configured to facilitate wired or wireless communications to and from external devices (e.g., network nodes such as access points, etc.).

At least some of the hardware entities 1514 perform actions involving access to and use of memory 1512, which can be a RAM, a disk drive, flash memory, a CD-ROM and/or another hardware device that is capable of storing instructions and data. Hardware entities 1514 can include a disk drive unit 1516 comprising a computer-readable storage medium 1518 on which is stored one or more sets of instructions 1520 (e.g., software code) configured to implement one or more of the methodologies, procedures, or functions described herein. The instructions 1520 can also reside, completely or at least partially, within the memory 1512 and/or within the CPU 1506 during execution thereof by the computing device 1500. The memory 1512 and the CPU 1506 also can constitute machine-readable media. The term “machine-readable media”, as used here, refers to a single medium or multiple media (e.g., a centralized or distributed database, and/or associated caches and servers) that store the one or more sets of instructions 1520. The term “machine-readable media”, as used here, also refers to any medium that is capable of storing, encoding or carrying a set of instructions 1520 for execution by the computing device 1500 and that cause the computing device 1500 to perform any one or more of the methodologies of the present disclosure.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A method for operating a system, comprising:
generating sensor data by at least one sensor of a waste receptacle that specifies at least one characteristic of at least one item;
performing operations by the waste receptacle to identify first media content that is associated with the at least one characteristic of the at least one item;
when the first media content is identified by the waste receptacle, causing the first media content to be output from the waste receptacle or an external device; and
when the first media content is unable to be identified by the waste receptacle, selecting second media content different from the first media content and causing the second media content to be output from the waste receptacle or the external device.

2. The method according to claim 1, wherein the at least one characteristic of the at least one item comprises a type of item, a type of waste that the at least one item comprises, a physical appearance of the at least one item, a condition of the at least one item, a source of the at least one item, a tradename for the at least one item, a product identifier for the at least one item, label information for the at least one item, contents of the at least one item, a group to which the at least one item belongs, a ranking or importance of the at least one item relative to other items, or a ranking or importance of the source of the at least one item relative to a source of at least one other item.

3. The method according to claim 1, wherein the external device comprises (i) a mobile communication device of an individual who has or has possession of the at least one item or (ii) a presentation device located near the waste receptacle device.

4. The method according to claim 1, further comprising performing operations by the waste receptacle to detect when a first item and a second item is disposed therein within a period starting from when the first item was detected in proximity to the waste receptacle.

5. The method according to claim 4, wherein the sensor data specifies characteristics of the first item and the second item.

6. The method according to claim 5, further comprising using the characteristics of the first and second items to obtain information comprising at least one of an identifier for a group to which the first and second items belong, an identification of a common source for the first and second items, relative importance for the first and second items, and a weighted value.

7. The method according to claim 1, wherein the second media content is selected randomly.

8. The method according to claim 1, wherein the second media content is selected based on a time of day, a geographic location of the waste receptacle, a total number of individuals detected in proximity to the waste receptacle at a given time, physical characteristics of individuals proximate to the waste receptacle, types of electronic devices in possession of the individuals proximate to the waste receptacle, a given degree of the at least one item's popularity amongst a population, or an average number of items processed by the waste receptacle in a given period.

9. The method according to claim 1, further comprising analyzing the sensor data to obtain individual-based information and using the individual-based information to select the second media content.

10. The method according to claim 9, wherein the individual-based information comprises at least one of an identifier for an individual proximate to the waste receptacle, information indicating a popularity of an item type amongst persons having at least one trait in common with the individual proximate to the waste receptacle, and information indicating a total or average number of items of the same or similar type that has historically been processed by waste receptacle during a given period.

11. A waste receptacle, comprising:
a processor;
a non-transitory computer-readable storage medium comprising programming instructions that are configured to cause the processor to implement a method for operating the waste receptacle, wherein the programming instructions comprise instructions to:
obtain sensor data specifying at least one characteristic of at least one item;
identify first media content that is associated with the at least one characteristic of the at least one item;
when the first media content is identified by the processor, cause the first media content to be output from the waste receptacle or an external device; and
when the first media content is unable to be identified by the processor, select second media content different from the first media content and cause the second media content to be output from the waste receptacle or the external device.

12. The waste receptacle according to claim 11, wherein the at least one characteristic of the at least one item comprises a type of item, a type of waste that the at least one item comprises, a physical appearance of the at least one item, a condition of the at least one item, a source of the at least one item, a tradename for the at least one item, a product identifier for the at least one item, label information for the at least one item, contents of the at least one item, a group to which the at least one item belongs, a ranking or importance of the at least one item relative to other items, or a ranking or importance of the source of the at least one item relative to a source of at least one other item.

13. The waste receptacle according to claim 11, wherein the external device comprises (i) a mobile communication device of an individual who has or has possession of the at least one item or (ii) a presentation device located near the waste receptacle device.

14. The waste receptacle according to claim 11, wherein the programming instructions further comprises instructions to detect when a first item and a second item is disposed in the waste receptacle within a period starting from when the first item was detected in proximity to the waste receptacle.

15. The waste receptacle according to claim 14, wherein the sensor data specifies characteristics of the first item and the second item.

16. The waste receptacle according to claim 15, wherein the programming instructions further comprises instructions to use the characteristics of the first and second items to obtain information comprising at least one of an identifier for a group to which the first and second items belong, an identification of a common source for the first and second items, relative importance for the first and second items, and a weighted value.

17. The waste receptacle according to claim 11, wherein the second media content is selected randomly.

18. The waste receptacle according to claim 11, wherein the second media content is selected based on a time of day, a geographic location of the waste receptacle, a total number of individuals detected in proximity to the waste receptacle at a given time, physical characteristics of individuals proximate to the waste receptacle, types of electronic devices in possession of the individuals proximate to the waste receptacle, a given degree of the at least one item's popularity amongst a population, or an average number of items processed by the waste receptacle in a given period.

19. The waste receptacle according to claim 11, wherein the programming instructions further comprises instructions to analyze the sensor data to obtain individual-based information an using the individual-based information to select the second media content.

20. The waste receptacle according to claim 19, wherein the individual-based information comprises at least one of an identifier for an individual proximate to the waste receptacle, information indicating a popularity of an item type amongst persons having at least one trait in common with the individual proximate to the waste receptacle, and information indicating a total or average number of items of the same or similar type that has historically been processed by waste receptacle during a given period.
